(19) United States
(12) Patent Application Publication
(10) Pub. No.: US 2014/0089108 A1
(43) Pub. Date: Mar. 27, 2014

(54) SYSTEMS AND METHODS FOR RECOMMENDED BROWSING

(71) Applicant: Brand Enforcement Services Limited, Beaverton, OR (US)

(72) Inventor: Edwin Tan, Hong Kong (CN)

(73) Assignee: BRAND ENFORCEMENT SERVICES LIMITED, Beaverton, OR (US)

(21) Appl. No.: 13/791,701

(22) Filed: Mar. 8, 2013

Related U.S. Application Data
(60) Provisional application No. 61/652,088, filed on May 25, 2012.

(51) Int. Cl. G06F 17/30

(52) U.S. Cl. CPC G06F 17/30899
USPC 705/14.73; 707/736; 707/748

(57) ABSTRACT

Various of the disclosed embodiments relate to systems and methods for recommended browsing. More specifically, various embodiments relate to systems and methods for monitoring a user's Internet browsing and for providing recommendations to other websites to the user. The other websites may be of interest to the user and/or may also concern evaluations of the original website browsed by the user

### CROSS-REFERENCE TO RELATED APPLICATIONS

This application claims priority to the U.S. Provisional Application 61/652,088, entitled SYSTEMS AND METHODS FOR RECOMMENDED BROWSING, filed on May 25, 2012.

### TECHNICAL FIELD

Various of the disclosed embodiments relate to systems and methods for recommended browsing.

### BACKGROUND

The Internet provides a plethora of opportunities to discover and learn from a remarkable range of resources. Unfortunately, the very diversity of the Internet's resources may also make it difficult to identify all the information relevant to a user. It may also be difficult to direct a user to information or resources on related websites, Accordingly, there exists a need for systems and methods which facilitate user notification and redirection to relevant Internet resources at an appropriate time and manner.

### SUMMARY

Certain of the disclosed embodiments contemplate a computer-implemented method for recommended browsing comprising: generating a recommendation request including a current URL; receiving a recommended browsing list based at least in part on the recommendation request, the recommended browsing list comprising entries associated with a plurality of URLs; and generating a display to a user based on at least a portion of the recommended browsing list.

In some embodiments the display comprises an image associated with an entry from the recommended browsing list. In some embodiments, the display comprises a screenshot associated with an entry from the recommended browsing list. In some embodiments, the method further comprises receiving a request from a browser plug-in. In some embodiments, the recommended browsing list comprises at least one paid advertised recommendation. In some embodiments, the recommendation request includes an indication of the user's identity.

Certain embodiments contemplate a computer-implemented method for generating browsing recommendations comprising: receiving: a URL; evaluating a website associated with the URL; generating a set of recommendations based on the evaluation, the set of recommendations including references to a plurality of URLs; and transmitting the set of recommendations,

In some embodiments, evaluating a website associated with the URL comprises determining if the website has been indexed in a historical database. In some embodiments, the method further comprises retrieving the website and supplementing the historical database with information associated with the website. In some embodiments, evaluating the website comprises retrieving user rankings associated with the website from a historical database. In some embodiments, evaluating the website comprises retrieving user comments associated with the website from a historical database. In some embodiments, evaluating a website associated with the URL comprises retrieving social network information associated with the user from a database. In some embodiments, generating a set of recommendations comprises retrieving; one or more paid advertised recommendations from a database.

Certain embodiments contemplate a non-transitory computer-readable medium comprising instructions configured to cause a processor to perform a method comprising: receiving a URL; evaluating a website associated with the URL; generating a set of recommendations based on the evaluation, the set of recommendations including references to a plurality of URLs; and transmitting the set of recommendations.

In some embodiments, evaluating a website associated with the URL comprises determining if the website has been indexed in a historical database. In some embodiments, the method performed by the processor further includes retrieving the website and supplementing the historical database with information associated with the website. In some embodiments, evaluating the website comprises retrieving user rankings associated with the website from a historical database. In some embodiments, evaluating the website comprises retrieving user comments associated with the website from a historical database. In some embodiments, evaluating a website associated with the URL comprises retrieving social network information associated with the user from a database. In some embodiments, generating a set of recommendations comprises retrieving one or more paid advertised recommendations from a database.

### BRIEF DESCRIPTION OF THE DRAWINGS

One or more embodiments of the present disclosure are illustrated by way of example and not limitation in the figures of the accompanying drawings, in which like references indicate similar elements.

FIG. 1 illustrates an example of an environment 100 for recommended browsing in which some embodiments may be utilized.

FIG. 2 is a flow chart illustrating exemplary operations 200 for generating browsing recommendations to a user in accordance with some embodiments.

FIG. 3 is a flow chart illustrating exemplary operations 300 for operating a recommended browsing system in accordance with various embodiments.

FIG. 4 is an example of a computer system 400 with which embodiments may be utilized.

### DETAILED DESCRIPTION

Various of the disclosed embodiments relate generally to systems and methods for recommended browsing. More specifically, various embodiments relate to systems and methods for monitoring a user's internet browsing and for providing recommendations to other websites that may be of interest to the user. The system may also present websites to the user which provide evaluations of the intended website. In some embodiments, a user can install a plug-in or toolbar as part of a web browser that allows for the techniques discussed herein. Other embodiments provide for a custom web browser that can provide browsing recommendations and evaluation of the current web address provided by the user.

In some embodiments, each URL visited by the user can be transmitted to a central server for evaluation before the website is returned. The central server can have an index of URLs with an evaluation status. If the URL is one that has not already recently been indexed, then the URL can visit the site and perform an evaluation update. If the URL is not in the database, then the URL can be indexed and saved in the database, In some embodiments a screenshot of the webpage associated with the URL may also be saved in the database.

In some embodiments, the system can perform a relational analysis to determine which other URLs are worth visiting. For each other URL that the system determines is worth visiting, a thumbnail, full screenshot, text summary, user recommendations, or other information can be provided to the user with mouse-over gestures providing even more information. In some embodiments, the social network of the user can be used in determining the other URLs that are worth visiting. In addition, the URLs can be ranked by friends of the user or by the user himself. Some embodiments may allow for comments in addition to a ranking. This additional information can be used by the system in the relational analysis. For example, the system may perform a textual analysis of the user's friends' comments and may use keywords in the text when identifying URLs worth visiting. In at least one embodiment, the list of recommended results could have some paid results (e.g., advertisements).

Alerts may be provided in some embodiments when the user visits dangerous/bad sites. The dangerous/bad sites may be detected or identified by scanning the contents of a page. The dangerous/bad site may also be manually flagged by users of system.

In the following description, for the purposes of explanation, numerous specific details are set forth in order to provide a thorough understanding of certain disclosed embodiments. It will be apparent, however, to one skilled in the art that various embodiments may be practiced without some of these specific details.

The techniques introduced here can he embodied as special-purpose hardware (e.g., circuitry), or as programmable circuitry appropriately programmed with software and/or firmware, or as a combination of special-purpose and programmable circuitry. Hence, embodiments may include a machine-readable medium having stored thereon instructions which may be used to program a computer (or other electronic devices) to perform a process. The machine-readable medium may include, but is not limited to, floppy diskettes, optical disks, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

The phrases “in some embodiments,” “according to various embodiments,” “in the embodiments shown,” “in one embodiment,” “in other embodiments,” and the like generally mean the particular feature, structure, or characteristic following the phrase is included in at least one embodiment, and may be included in more than one embodiment. In addition, such phrases do not necessarily refer to the same embodiments or different embodiments.

if the specification states a component or feature “may”, “can”, “could”, or “might” be included or have a characteristic, that particular component or feature is not required to be included or have the characteristic.

The term “network” generally refers to a group of interconnected devices capable of exchanging information. A network may be as few as several personal computers on a Local Area Network (LAN) or as large as the Internet, a worldwide network of computers. As used herein “network” is intended to encompass any network capable of transmitting information from one entity to another. In some cases, a network may be comprised of multiple networks, even multiple heterogeneous networks, such as one or more border networks, voice networks, broadband networks, service provider networks, Internet Service Provider (ISP) networks, and/or Public Switched Telephone Networks (PSTNs), interconnected via gateways operable to facilitate communications between and among the various networks.

### General Description

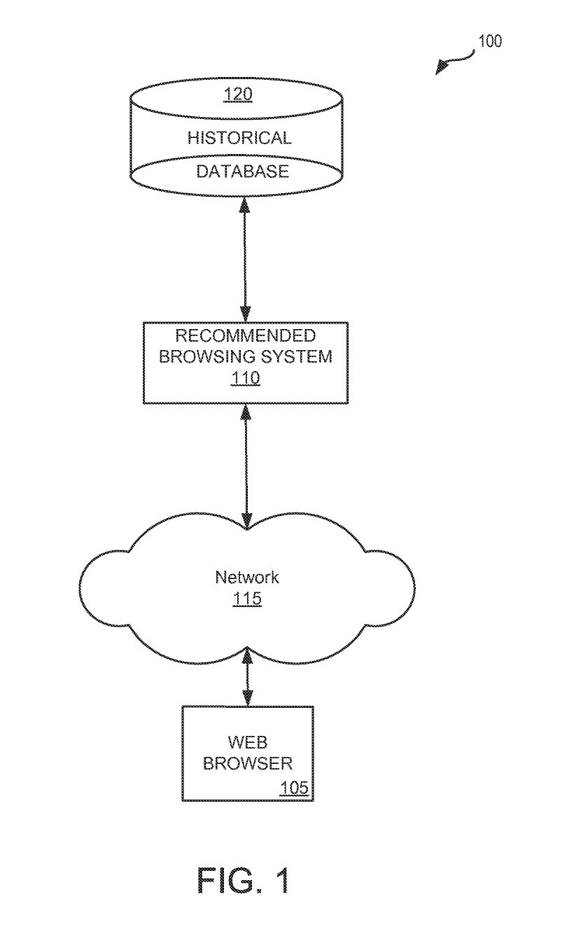

FIG. 1 illustrates an example of an environment 100 for recommended browsing in which some embodiments may be utilized. The environment 100 illustrated in FIG. 1 includes a web browser 105, recommended browsing system 110, network 115, and historical database 120. The browser 105 can access the recommended browsing system 110 through network 115.

Recommended browsing system 110 can automatically scan websites and generate one or more entries within historical database 120. Each entry may contain information such as the last time the website was evaluated, threats found on the website, content categories, snapshots of the website, reviews and rankings from other users, along with many other types of information. When a user enters a domain name or IP address within browser 105, the address may be transmitted to recommended browsing: system 110. System 110 may perform an analysis to determine if the website is safe along with generating a set of sites to recommend to the user.

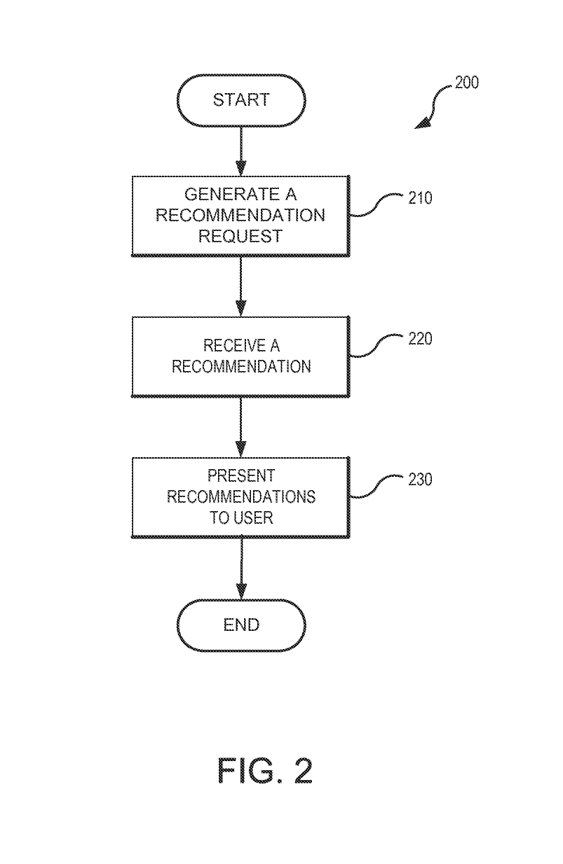

FIG. 2 is a flow chart illustrating exemplary operations 200 for generating browsing recommendations to a user in accordance with some embodiments. As illustrated in FIG. 2, a web browser, plug-in, or toolbar on a computer uses generation operation 210 to generate a recommendation request. The recommendation request can include a variety of fields, such as a user identifier, recent browsing history, current URL, key words supplied by the user or other program, user location, and others. The recommendation request can be submitted to a recommended browsing system that generates a recommended browsing list. This list generated by the browsing system may be received during receiving operation 220. The information contained with the list may then be presented to the user with presentation operation 230. For example, the system may display the list of recommendations as an HTML element and may include screenshots of the recommended sites.

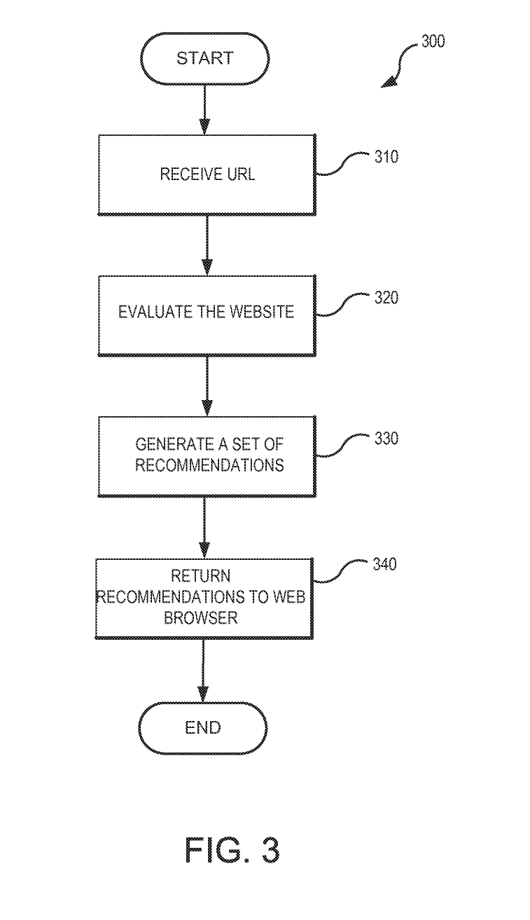

FIG. 3 is a flow chart illustrating exemplary operations 300 for operating a recommended browsing system in accordance with various embodiments. During receiving operation 310, the recommended browsing system receives a URL or recommendation request from a web browser. The website associated with the URL may be evaluated during evaluation operation 320. Evaluation operation 320 can include accessing a historical database to retrieve any available entry associated with the website. The entry can include information about the content of the website, snapshots of the website, results from a threat analysis, comments and rankings from users, date and time of the last evaluation, and other types of information.

If the URL is one that has not already recently been indexed, then the recommended browsing system can visit the site and perform an updated evaluation. If the URL is not in the database, then the URL can be indexed and saved in a new entry within the database along with a screenshot. Once the information about the URL has been collected, recommendation operation 330 may generate a set of recommended websites for the user. In some embodiments, the social network of the user can be used in determining the other URLs that are worth visiting. In addition, the URLs can be ranked by friends of the user or by the user herself Some embodiments allow for comments in addition to a ranking. This additional information can be used by the system in the relational analysis. In at least one embodiment, the list of recommended results could have some paid results (i.e., advertisements), Presentation operation 340 may present the recommended list and other information to the user, e.g., as a thumbnail, full screenshot, text summary, user recommendations, or in another fashion.

### Exemplary Computer System Overview

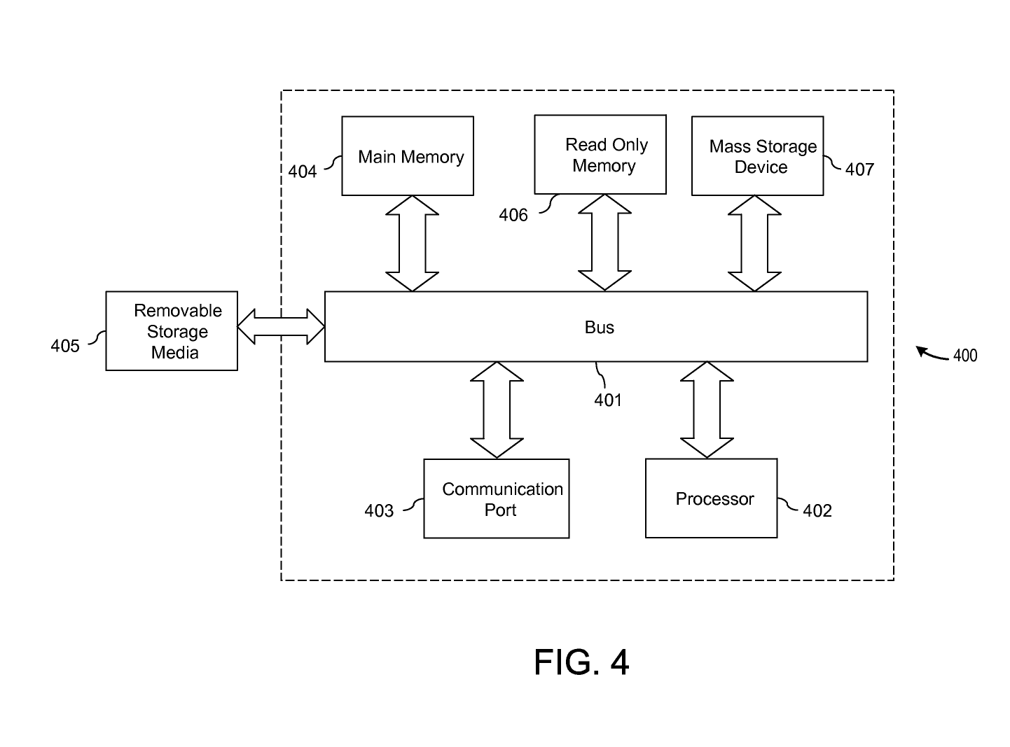

Certain embodiments may include various steps and operations, which have been described above. A variety of these steps and operations may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware. As such, FIG. 4 is an example of a computer system 400 with which various embodiments may be utilized. Recommended Browsing System 110 may be located on computer system 400. According to the present example, the computer system includes a bus 401, at least one processor 402, at least one communication port 403, a main memory 404, a removable storage media 405, a read only memory 406, and a mass storage 407.

Processor(s) 402 can be any known processor, such as, but not limited to, an Intel® Itanium® or Itanium 2® processor(s), or AMD® Opteron® or Athlon MP® processor(s), or Motorola® lines of processors. Communication port(s) 403 can be any of an RS-232 port for use with a modem based dialup connection, a 10/100 Ethernet port, or a Gigabit port using copper or fiber. Communication port(s) 403 may be chosen depending on a network such a Local Area Network (LAN), Wide Area Network (WAN), or any network to which the computer system 400 connects.

Main memory 404 can be Random Access Memory (RAM), or any other dynamic storage device(s) commonly known in the art. Read only memory 406 can be any static storage device(s) such as Programmable Read Only Memory (PROM) chips for storing static information such as instructions for processor 402.

Mass storage 407 can be used to store information and instructions. For example, hard disks such as the Adaptec® family of SCSI drives, an optical disc, an array of disks such as RAID, such as the Adaptec family of RAID drives, or any other mass storage devices may be used.

Bus 401 communicatively couples processor(s) 402 with the other memory, storage and communication blocks. Bus 401 can be a PCI/PCI-X or SCSI based system bus depending on the storage devices used.

Removable storage media 405 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM).

The components described above are meant to exemplify some types of possibilities. In no way should the aforementioned examples limit the scope of the disclosed embodiments, as they are only exemplary embodiments.

In conclusion, various of the disclosed embodiments provide novel systems, methods and arrangements for recommended browsing. While detailed descriptions of one or more embodiments have been given above, various alternatives, modifications, and equivalents will be apparent to those skilled in the art without varying from the spirit of the disclosed embodiments. For example, while certain of the embodiments described above may refer to particular features, the scope of this disclosure also includes embodiments having different combinations of features and embodiments that do not include all of the described features. Accordingly, the scope of the disclosed embodiments is intended to embrace all such alternatives, modifications, and variations. Therefore, the above description should not be taken as limiting the scope of the disclosed embodiments.

What is claimed is:

1. A computer-implemented method for recommended browsing comprising:
generating a recommendation request including a current URL;
receiving a recommended browsing list based at least in part on the recommendation request, the recommended browsing list comprising entries associated with a plurality of URLs; and
generating a display to a user based on at least a portion of the recommended browsing list.

2. The computer-implemented method of claim 1, wherein the display comprises an image associated with an entry from the recommended browsing list.

3. The computer-implemented method of claim 1, wherein the display comprises a screenshot associated with an entry from the recommended browsing list.

4. The computer-implemented method of claim 1, further comprising receiving a request from a browser plug-in.

5. The computer-implemented method of claim 1, wherein the recommended browsing list comprises at least one paid advertised recommendation.

6. The computer-implemented method of claim 1, wherein the recommendation request includes an indication of the user's identity.

7. A computer-implemented method for generating browsing recommendations comprising:
receiving a URL;
evaluating a website associated with the URL;
generating a set of recommendations based on the evaluation, the set of recommendations including references to a plurality of URLs; and
transmitting the set of recommendations.

8. The computer-implemented method of claim 7, wherein evaluating a website associated with the URL comprises determining if the website has been indexed in a historical database.

9. The computer-implemented method of claim 8, further comprising retrieving the website and supplementing the historical database with information associated with the website.

10. The computer-implemented method of claim 7, wherein evaluating the website comprises retrieving user rankings associated with the website from a historical database.

11. The computer-implemented method of claim 9, wherein evaluating the website comprises retrieving user comments associated with the website from a historical database.

12. The computer-implemented method of claim 7, wherein evaluating a website associated with the URL comprises retrieving social network information associated with a user from a database.

13. The computer-implemented method of claim 7, wherein generating a set of recommendations comprises retrieving one or more paid advertised recommendations from a database.

14. A non-transitory computer-readable medium comprising instructions configured to cause a processor to perform a method comprising:
receiving a URL;
evaluating a website associated with the URL;
generating a set of recommendations based on the evaluation, the set of recommendations including references to a plurality of URLs; and
transmitting the set of recommendations.

15. The non-transitory computer-readable medium of claim 14, wherein evaluating a website associated with the URL comprises determining if the website has been indexed in a historical database.

16. The non-transitory computer-readable medium of claim 15, further comprising retrieving the website and supplementing the historical database with information associated with the website.

17. The non-transitory computer-readable medium of claim 14, wherein evaluating the website comprises retrieving user rankings associated with the website from a historical database.

18. The non-transitory computer-readable medium of claim 14, wherein evaluating the website comprises retrieving: user comments associated with the website from a historical database.

19. The non-transitory computer-readable medium of claim 14, wherein evaluating a website associated with the URL comprises retrieving social. network information associated with a user from a database.

20. The non-transitory computer-readable medium of claim 14, wherein generating a set of recommendations comprises retrieving one or more paid advertised recommendations from a database.
